(19) United States
(12) Patent Application Publication
(10) Pub. No.: US 2012/0221788 A1
(43) Pub. Date: Aug. 30, 2012

(54) MULTI-DIMENSIONAL ARRAY MANIPULATION

(75) Inventor: Sudarshan Raghunathan, Cambridge, MA (US)

(73) Assignee: Microsoft Corporation, Redmond, WA (US)

(21) Appl. No.: 13/037,251

(22) Filed: Feb. 28, 2011

(51) Int. Cl. G06F 12/00

(52) U.S. Cl. 711/114; 711/E12.001

(57) ABSTRACT

Method, system, and utility for performing an operation on data represented as elements of a multi-dimensional array. Operation on the data in the array may comprise performing a plurality of iterations. In each iteration, a plurality of elements in the array, stored contiguously in a first memory, may be selected based at least on a selected dimension of the array. The selected plurality of elements may be loaded into a second memory and a binary operator may be applied to each element of the selected plurality of elements and another element stored in the second memory. The second memory may have a smaller latency than the first memory.

### BACKGROUND

Representing data using multi-dimensional arrays and manipulating data through this representation is an essential feature of many computer programming languages, scientific computing platforms, and parallel and distributed computing environments. Such data representations are used to address problems in a wide variety of fields including digital signal processing, bioinformatics, computational chemistry, pattern recognition, and fluid dynamics, among others.

To represent data as a multi-dimensional array, conventional programming languages and computing platforms enable access to elements of the array, which are stored in physical computer memory. This may be accomplished by mapping each array index, identifying an element in the multi-dimensional array, to a location in physical computer memory at which the element is stored. For instance, the element stored in the first row and the first column of a two-dimensional array may be stored at one memory location and the element stored in the first row and the second column of the same matrix may be stored at another memory location.

The vast majority of computational algorithms relying on multi-dimensional array representations iterate over elements in multi-dimensional arrays and, at each iteration, perform an operation on an array element. In turn, iterating over elements of a multi-dimensional array requires accessing physical memory to retrieve the data represented by the array. For instance, iterating over elements of a two-dimensional array to compute the sum of elements of a row necessitates retrieving the elements stored in each column of the two-dimensional array at the row from physical memory. More generally, iterating over elements of a multi-dimensional array to compute the sum of array elements along a selected dimension {iterating over a row or first dimension of a two-dimensional array is a special case) necessitates retrieving the corresponding elements stored in the other dimensions {columns in the two-dimensional special case) from physical memory.

To efficiently iterate over data represented using multi-dimensional arrays, array elements need to be retrieved from physical memory locations at which they are stored as quickly as possible. However, when data is stored in a high-latency memory (e.g., a hard disk), each memory access may be time consuming. In this case, it is desirable to retrieve all the data required for processing by accessing the high-latency memory as few times as possible. Elements that are stored contiguously in the high-latency memory may require fewer memory accesses than elements which are not stored contiguously.

Two-dimensional arrays provide a well-known example of this situation. Conventionally, two-dimensional arrays are stored linearly in memory, using either “column-major” order or “row-major” order. In column-major order, every column of array elements is stored contiguously in memory, and the columns are stored sequentially. In this case, iterating over elements in a column may be implemented efficiently because all the elements in the column are contiguously stored in memory. However, iterating over a row of elements requires accessing elements that are not stored contiguously in memory. When each column contains a large number of elements, iterating over row elements requires accessing elements stored far apart in memory and, potentially, accessing high-latency memory multiple times, resulting in delays that are unacceptable in many applications. Similarly, when a two-dimensional matrix is stored in row-major order, large strides (i.e., sequential of elements stored non-contiguously in memory) may be required to iterate over column elements, potentially leading to accessing high-latency memory multiple times.

Multi-dimensional arrays are also linearly stored in physical memory. In the two-dimensional setting, column-major order refers to storing elements according to their position in the first dimension (row) and then according to their position in the last dimension (column). Likewise, row-major order refers to storing elements according to their position in the last dimension (column) and then according to their position in the first dimension (row). More generally, for arrays with two or more dimensions, column-major order refers to storing elements according to their position in every dimension ordered from first to last, whereas row-major order refers to storing elements according to their position in every dimension ordered from last to first. Though elements of a multi-dimensional array may be stored linearly in memory according to an arbitrary sequence of the array dimensions, multi-dimensional arrays are conventionally stored either in column-major form or in row-major form.

A conventional approach to iterating across elements of a two-dimensional array in a memory-efficient manner (e.g., by reducing the number of high-latency memory accesses) involves transposing the array so that array elements are always accessed along a preferred dimension. For instance, to compute a row sum of a two-dimensional matrix stored in column-major order, the matrix is transposed in memory and the desired result is obtained by computing a column sum of the transposed matrix.

### SUMMARY

Operation of a computing system that manipulates large multi-dimensional arrays may be improved by structuring certain operations. Certain operations, such as scans performed on arrays of three dimensions or higher, may be performed by iteratively drawing chunks of data into an active memory from a large capacity, but slower, memory. Processing can be performed on the chunk in the active memory. The size of each chunk may depend on the structure of the matrix, the operation to be performed, and the manner in which the data is stored in the large capacity memory.

In some embodiments, a method is provided for performing an operation on data represented as elements of a first multi-dimensional array. The method may comprise performing a plurality of iterations to compute output comprising one or more multi-dimensional arrays, the one or more multi-dimensional array comprising at least a second multi-dimensional array. Each iteration may comprise selecting a plurality of elements of the first multi-dimensional array, the plurality of elements stored contiguously in a first memory, loading the selected plurality of elements into a second memory, and applying an operator requiring two operands to each element of the selected plurality of elements and another element stored in the second memory, using at least one processor. The first multi-dimensional array may comprise at least three dimensions and may be stored in row-major order.

In some embodiments, a system is provided for performing an operation on data represented as elements of a first multi-dimensional array. The system may comprise a first memory to store the first multi-dimensional array in row-major order, the first multi-dimensional array having at least three dimensions, and at least one processor coupled to at least a second memory, the at least one processor programmed to perform a plurality of iterations to compute a second multi-dimensional array. Each iteration in the plurality of iterations may comprise selecting a plurality of elements of the first multi-dimensional array, based at least on a selected dimension of the first multi-dimensional array, wherein elements of the selected plurality of elements are stored contiguously in the first memory, loading the selected plurality of elements into the second memory, and applying an operator requiring two operands to each element of the selected plurality of elements and another element stored in the second memory.

In some embodiments, a computer-readable storage medium encoded with a utility, may be provided, the utility comprising processor-executable instructions that, when executed by at least one processor, cause the processor to perform a plurality of iterations to compute a second multi-dimensional array from a first multi-dimensional array. Each iteration in the plurality of iterations may comprise selecting a plurality of elements of the first multi-dimensional array, based at least on a selected dimension of the first multi-dimensional array and how many elements are stored in each dimension of the first multi-dimensional array, the selected plurality of elements stored contiguously in a first memory. Each iteration may further comprise loading the selected plurality of elements into a second memory, the second memory containing another plurality of elements, wherein each element of the selected plurality of elements has a corresponding element in the other plurality of elements, and applying an operator requiring two operands to each element of the selected plurality of elements and its corresponding element in the other plurality of elements. The first multi-dimensional array may comprise at least three dimensions and may be stored in row-major order.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of an illustrative computer system that may be used to perform operations on elements of a multi-dimensional array, in accordance with some embodiments of the present disclosure.

FIGS. 2a-2c illustrate how elements of a multi-dimensional array may be arranged for storage in memory, in accordance with some embodiments of the present disclosure.

FIGS. 3a-3b illustrate a class of operations that may be performed on multi-dimensional arrays with respect to a selected dimension, in accordance with some embodiments of the present disclosure.

FIGS. 3c-3d illustrate another class of operations that may be performed on multi-dimensional arrays with respect to a selected dimension, in accordance with some embodiments of the present disclosure.

FIGS. 4a-4d show aspects of performing operations on an illustrative four-dimensional array with respect to a selected dimension, in accordance with some embodiments of the present disclosure.

FIGS. 5a-5b show examples of different sub-arrays of a two-dimensional array.

FIG. 6a shows computer program pseudo-code for computing reductions with respect to a selected dimension of a two-dimensional array.

FIG. 6b shows computer program pseudo-code for computing reductions with respect to another selected dimension of a two-dimensional array.

FIGS. 7a-7b illustrate computer-program pseudo-code for computing matrix-vector products.

FIG. 8 illustrates computer program pseudo-code for computing reductions along a selected dimension of a multi-dimensional array.

FIG. 9 shows a table of parameters computed when the computer program of FIG. 8 is applied to the four-dimensional example illustrated in FIGS. 4a-4d.

FIG. 10 shows a flow chart of an illustrative process that may be used to perform operations on elements of a multi-dimensional array, in accordance with some embodiments of the present disclosure.

FIG. 11 is a block diagram generally illustrating an example of a computer system that may be used in implementing aspects of the present disclosure.

### DETAILED DESCRIPTION

The inventors have recognized and appreciated the need for a memory-efficient approach to iterating over multi-dimensional arrays, stored either in row-major or in column-major order, that reduces a potentially large number of high-latency memory accesses. The inventors have further appreciated that, when multi-dimensional arrays are stored linearly in memory, iterating over all but one of the dimensions of each multi-dimensional array requires large strides across memory locations at each iteration, potentially leading to multiple accesses of high-latency memory. For instance if a multi-dimensional array is stored in column-major order, iterating over any dimension other than the first dimension may require large strides across memory locations at each iteration. Similarly, if a multi-dimensional array is stored in row-major order, iterating over any dimension other than the last dimension may require large strides across memory locations at each iteration.

The inventors have also recognized and appreciated that the conventional approach of transposing a two-dimensional array is an inefficient approach to iterating over a row (resp. column) of a two-dimensional array stored in column-major (resp. row-major) form, because transposing a matrix in memory is time consuming. Furthermore, the inventors have appreciated that this approach does not easily generalize to higher-dimensional arrays. Though, it may be possible to generalize the notion of a transpose operation to higher dimensions, the resultant approach would require time-consuming manipulation of the matrix in memory.

The inventors have further appreciated that a memory-efficient approach to iterating over multi-dimensional arrays may be applied to both dense and sparse (i.e., containing many zeros) arrays and that such an approach may take advantage of conventional techniques for representing sparse arrays. The inventors have also recognized that such an approach may be used to implement broad classes of operations including array reductions and scans.

In some embodiments, the data represented by a multi-dimensional array, stored in column-major or row-major order, may be loaded in chunks comprising continuously-stored elements in high-latency memory, from the high-latency memory (e.g., a hard drive) to a low-latency memory (e.g., onboard processor cache) for subsequent processing by a processor. In turn, iterations over data represented by a multi-dimensional array may be realized by a sequence of iterations over the chunks in the low-latency memory. Iterating over chunks in a low-latency memory may substantially decrease the number of high-latency memory accesses and improve overall performance.

The inventors have further realized and appreciated that the manner in which data, represented by a multi-dimensional array, may be broken up into contiguous memory chunks for subsequent processing may determine how many accesses to high-latency memory may be required during subsequent processing. In some embodiments, data may be partitioned (i.e., divided into non-overlapping sets) into chunks based on a selected dimension along which an operation may be performed. For instance, one set of chunks may be used for computing a running sum along the third dimension of a four-dimensional 2×7×10×3 array and another set of chunks may be used for computing a running sum along the fourth dimension of the same array.

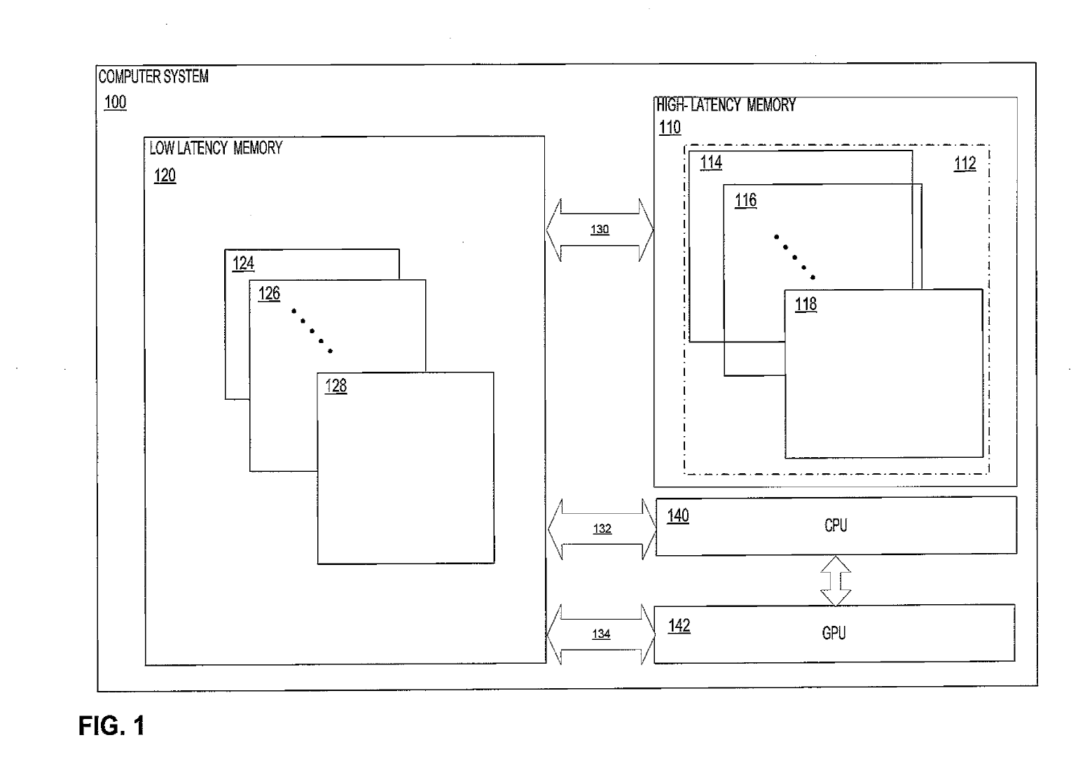

FIG. 1 shows an illustrative computer system 100 that may be used to perform operations on elements of an multi-dimensional array 112. Array 112 may be an array of arbitrary dimension—it may be a two- or a three- or a four-dimensional array or it may have more than four dimensions. Array 112 may represent any of numerous types of data. For instance, each element of array 112 may be of a primitive type such as an integer or a real number in floating point format and may comprise a specific number of bits. Alternatively, each element may be an object, such as any suitable object used in object-oriented programming. Additionally or alternatively, array elements may not be of the same data type and/or of the same size in memory. All these variations are known in the art and are conventionally used as part of software engineering and scientific computing.

Computer system 100 may comprise a high-latency memory 110 and a low-latency memory 120. Herein latency of a memory refers to an amount of time needed to access information from the memory. High latency-memory 110 may have a latency that is greater than the latency of low-latency memory 120.

High-latency memory may be a high capacity memory. It may be less frequently accessed and may be less expensive to manufacture than low-latency memory. Data may be transferred to high-latency memory for long-term storage, whereas data may be transferred to low-latency memory for subsequent manipulation by a processor which may access the low-latency memory repeatedly.

High-latency memory 110 may be any of numerous memories. For instance, memory 110 may comprise a hard disk, a magnetic disk, or an optical disc. As another example high-latency memory may be embodied as a computer readable storage medium (or multiple computer readable media) such as one or more floppy discs, compact discs (CD), optical discs, digital video disks (DVD), magnetic tapes, and flash memories. Still other examples comprise magnetic tape cassettes, flash memory cards, digital versatile disks, digital video tape, and the like.

Low-latency memory 120 may be any of numerous memories and may have a lower latency than high-latency memory 110. For instance, low-latency memory 120 may be an onboard cache, random-access memory (RAM), or any memory implemented using solid-state circuits.

Though it should be appreciated that the above-mentioned lists of examples of high- and low-latency memories 110 and 120, respectively, are not limiting and any memory may be used so long as the latency of the high-latency memory is higher than the latency of the low-latency memory. For instance, low-latency memory 120 may be a hard-drive which may have a lower latency than a magnetic tape, which may be high-latency memory 110. In addition, it should be recognized that the computer system 100 may comprise multiple memories in addition to the memories 110 and 120.

Multi-dimensional array 112 may be stored in high-latency memory 110 and may comprise a plurality of contiguously-stored elements termed chunks. In the example of FIG. 1, the plurality of chunks comprises chunks 114, 116 and 118.

Computer system 100 may be operable to iterate over elements of multi-dimensional array 112 and apply an operation to the array along a selected dimension by using one or more processors. The processors may be any of numerous types. For instance, computer system comprises central processing unit (CPU) 140 and graphics processing unit 142, each of which may be used to apply an operation to the array 112. Though, computer system 100 may comprise a plurality of CPUs and GPUs or any other type of microprocessor for performing operations on elements of the array. In some embodiments, each of the one or more processors may be a multi-core processor. For instance, the CPU processor 140 may be a dual core, a quad core or hex-core processor. Though, the exact number of cores in a processor is not critical and a processor comprising any number of cores may be used.

To iterate over elements of array 112, chunks constituting array 112 may be loaded from high-latency memory 110 to low-latency memory 120. The data may be transferred from one memory to the other using connection 130, which may be a system bus or any other suitable connection. For instance, chunk 114 of array 112 may be loaded from high-latency memory 110 to low-latency memory 120 using connection 130. Chunk 114 may be stored as chunk 124 in low-latency memory 120. Similarly, chunks 116 and 118 of array 112 may be loaded from high-latency memory to low-latency memory 120 and stored as chunks 126 and 128, respectively.

Once stored in low-latency memory 110, chunks may be stored in any of numerous ways. For instance, some chunks may be stored contiguously in low-latency memory, whereas others may be stored non-contiguously. Though in some embodiments all the chunks may be stored contiguously, and, in other embodiments, all the chunks may be stored non-contiguously in low-latency memory.

The computer system 100 may be operable to iterate over each of the chunks in low-latency memory and to perform an operation on elements of low-latency memory. An operation may comprise applying, an operator requiring two operands (i.e., a binary operator) to pairs of elements stored in low-latency memory. In some instances, the pair of elements may be stored as part of one chunk or may be stored in different chunk. The operator may be any binary operator such as addition, multiplication, subtraction, division, minimum, and maximum among others. A processor (e.g., CPU 140 or GPU 142) may be used to apply a binary operator to elements stored in low-latency memory.

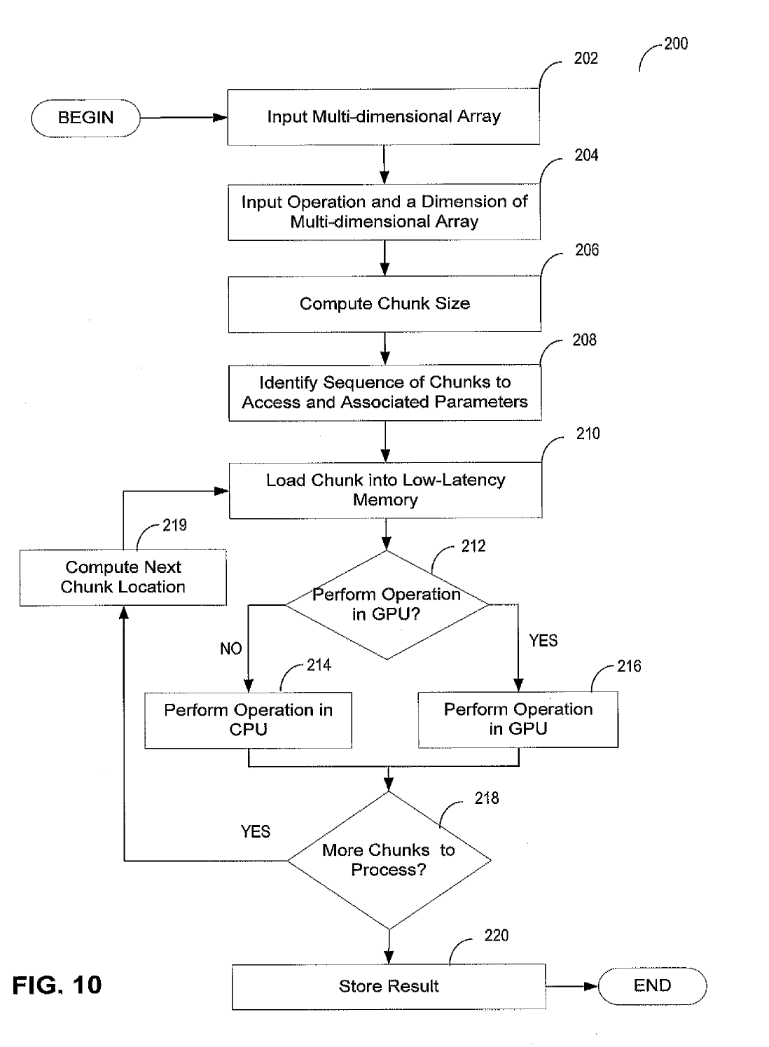

In some embodiments, the computer system 100 may perform a method for iteratively processing chunks comprising elements of array 112. At each iteration a chunk may be loaded from high-latency memory 110 to low-latency memory 120 and/or a process (e.g., CPU 140 or GPU 142) may be used to apply a binary operator to elements of the loaded chunk. This method is described in detail with reference to FIG. 10, below.

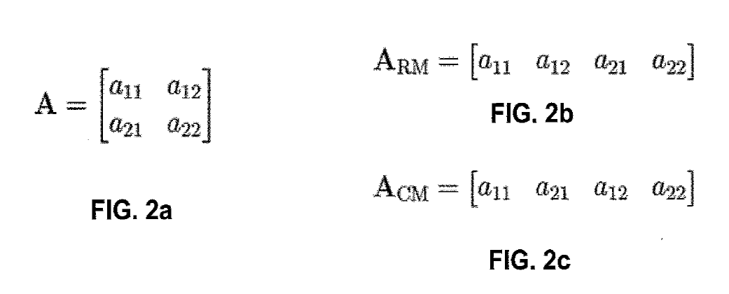

A multi-dimensional array may be stored in memory linearly. When the number of elements in an array is N where N is a positive integer, there are N×(N−1)×(N−2)× . . . ×2×1 (N factorial) ways, termed orders, of arranging these elements linearly and contiguously in memory. Though conventionally, only two of these orders—termed row-major and column-major orders—are used. FIGS. 2a-2c illustrate storing an example two-dimensional array in row-major and column-major orders.

FIG. 2a shows a simple 2×2 two-dimensional array (matrix) A. The matrix A may be stored linearly in memory in any of numerous ways. For instance, since the matrix has four entries, these elements may be linearly and contiguously arranged in 24 different ways. Though, conventionally the matrix A may be stored either in row-major or column-major order.

FIG. 2b illustrates how elements of A may be arranged in memory when A is stored in row-major order. Every row of elements is stored contiguously in memory and the second row is stored after the first row such that the first element of the second row is stored after the last element of the first row. In this case, iterating over elements in the first row and then elements in the second row may be accomplished by iterating over contiguously-stored elements in memory. In contrast, iterating over elements in first column (a₁₁ and a₂₁) requires accessing non-contiguously stored elements.

Though in the simple example illustrated in FIG. 2b iterating over elements in the first column may comprise accessing non-contiguously stored elements, these elements are only separated by one other element (a₁₂) in memory. Thus, a stride of size 2 may be used. More generally, however, strides of size m may be needed for a two-dimensional matrix with m rows and n columns. If the matrix were to have many rows (m is large), large strides may be required, potentially increasing the number of times high-latency memory may need to be accessed.

FIG. 2c illustrates how elements of A may be arranged in memory when A is stored in column-major order. Every column of elements is stored contiguously in memory and the second column is stored sequentially after the first column such that the first element in the second column is stored after the last element in the first column. In this case, iterating over elements in the first column and then elements in the second column may be accomplished by iterating over contiguously-stored elements in memory. In contrast, iterating over elements in the first row (a₁₁ and a₁₂) requires accessing non-contiguously stored elements.

In the two-dimensional case, row- and column-major orders identify the sequence of dimensions that controls the order in which elements are stored. In column-major order, elements are ordered in memory according to their position in the first dimension (what row they are in) and then according to their position in the second dimension (what column they are in) of the matrix. When a multi-dimensional array is stored in column-major order, its elements are ordered in memory according to their position in the first dimension, then according to their position in the second dimension, and so on until the last dimension. Thus, column-major order refers to storing elements of a multi-dimensional array with respect to a sequence of the dimensions from first to last.

In contrast, when a multi-dimensional array is stored in row-major order, elements are ordered in memory according to their position in the last dimension, their position in the second-to-last dimension, and so on until the first dimension. Thus row-major order refers to storing elements of an array with respect to a sequence of dimensions from last to first. Thus, in the two-dimensional case, elements are ordered in memory according to their position in the second dimension (what column they are in) and then according to their position in the first dimension (what column they are in) of the matrix.

It should be appreciated that even though multi-dimensional arrays are conventionally stored in row-major and column-major order, they may also be stored in any of suitable other orders. For instance, elements may be stored with respect to an arbitrary sequence of dimensions, and not just from first to last (column-major order) or from last to first (row-major order). For instance, an alternating sequence of dimensions (e.g., first, last, second, second-to-last, third, third-to-last etc.) may be used.

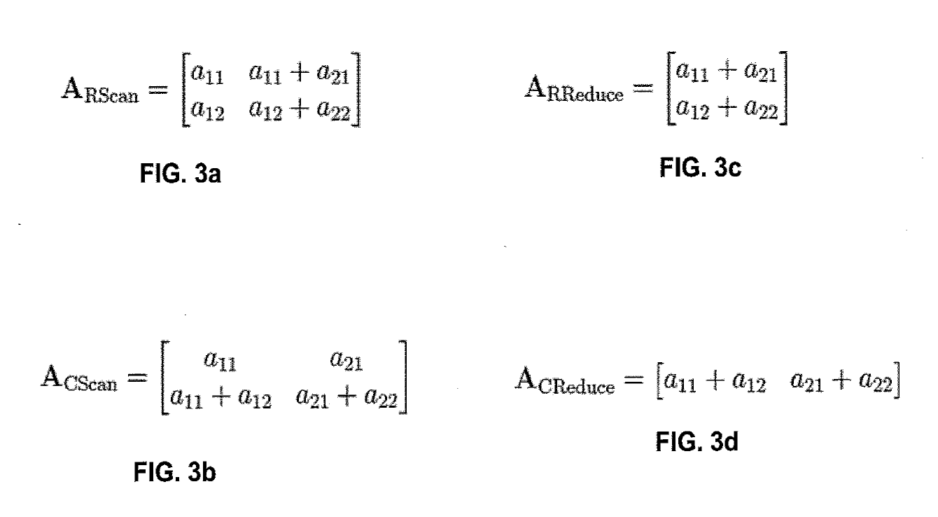

Many algorithms relying on multi-dimensional array representations of data, iterate over elements in multi-dimensional arrays and, at each iteration, perform an operation on an array element. Often, the iterations and the operation are defined with respect to a specific dimension of the multi-dimensional array. FIGS. 3a-3d illustrate two classes of such operations—termed scans and reductions—with respect to the two-dimensional matrix A shown in FIG. 2a.

A scan operation along a selected dimension of a multi-dimensional array A may be defined as follows. Define the scanned form of A along a dimension d to be a D-dimensional array Y having the same shape as the array A. Herein, shape of an array refers to the number of elements in each dimension of an array. For instance, the matrix A shown in FIG. 2a has shape: 2×2, whereas the matrix A_{RReduce} shown in FIG. 3c has shape 2×1. A scan, based on the sum operation, along dimension d may be defined as the following operation for each index j ranging from 1 to N_{d} (the number of elements in dimension d):

$$Y ( {i}_{1} , {i}_{2} , Λ , j , Λ {i}_{D} ) = {\sum }_{{i}_{d} = 1}^{j} A ( {i}_{1} , {i}_{2} , Λ , {i}_{d} , Λ , {i}_{D} )$$

Note that every value of the index j corresponds to a partial sum of the first j terms in the above summation.

Though in the above formulation, computing a scan along a selected dimension (first or second) involved computing a cumulative sum along that dimension, it should be recognized that a scan operation may involve computing any of numerous operators instead of the sum operator. For instance, a scan operation may comprise computing a cumulative product along a selected dimension. Examples of other operators include division, subtraction, minimum or maximum. Still, the invention is not limited to the aforementioned operations as any binary operator (i.e., any operator requiring two operands) may be used.

FIGS. 3a and 3b illustrate a scan computed along the first dimension (row) and the second dimension (column) of the two-dimensional matrix A shown in FIG. 2a. As shown in FIG. 3a, an example scan operation applied along the first dimension (row) of A produces an output array which contains the cumulative sum of the columns of A, along with the associated partial sums.

A scan may be computed along any dimension of the array A. In this simple example, a scan may also be computed along the second dimension (column) to compute a cumulative sum of the rows of A as illustrated in FIG. 3b.

FIGS. 3c and 3d illustrate another type of operation, called a reduction that may be performed with respect to a selected dimension of a multi-dimensional array. FIG. 3c shows an example of a reduction operation applied to the two-dimensional matrix A shown in FIG. 2a along the first dimension (row) so that the cumulative sum of the columns of A may be computed. Unlike the scan operation illustrated in FIG. 3a, intermediate results are not stored in this case.

As shown in FIG. 3d, a reduction operation may be applied to the array A along the second dimension (column) so that the cumulative sum of the rows of A may be computed. As in the case of scans, reductions are not limited to calculating sums. Any binary operator, such as multiplication or subtraction, may be used.

Reductions may be defined more formally, for multi-dimensional arrays of arbitrary dimension, as follows. Let A be a D-dimensional array of shape Nᵢ×N₂×N₃× . . . ×N_{D}. Define the reduced form of A along a dimension d to be a D-dimensional array Y of shape N₁×N₂×N₃× . . . ×1× . . . ×N_{D}, such that the d^{th} dimension has one entry. A reduction, based on the summation operation, along dimension d may be defined as

$$Y ( {i}_{1} , {i}_{2} , Λ , 1 , Λ {i}_{D} ) = {\sum }_{{i}_{d} = 1}^{{N}_{d}} A ( {i}_{1} , {i}_{2} , Λ , {i}_{d} , Λ , {i}_{D} )$$

Thus, the reduction along dimension d may computed by varying indices only along the d^{th} dimension of the matrix A. This definition is consistent with the earlier example of FIGS. 3c and 3d in which a reduction along rows computes the sum of the columns and vice versa. Though, as noted before, any binary operation may be used instead of the sum operation.

Since intermediate results are not stored when reductions are computed, the output multi-dimensional array has a different shape than the input multi-dimensional array. The shape of the output multi-dimensional array may differ from the shape of the input multi-dimensional array in the selected dimension with respect to which a reduction may be performed. For instance, the output multi-dimensional array may have one element in the selected dimension, whereas the input multi-dimensional array may have more than one element in the selected dimension.

As illustrated in the above examples, scans and reductions require iterating over elements of the arrays with respect to a selected dimension (rows or columns in the two-dimensional case). In turn, the memory efficiency (in this case measured by the number of memory accesses) of these iterations may depend on how the arrays are stored in memory. For instance, computing a scan along the first dimension of the matrix A (a row scan) as shown in FIG. 2a. may require accessing two elements non-contiguously stored in memory, if A is stored in column-major order. A naive implementation of the row scan for this example may involve accessing the element a₁₁, followed by a₂₁, followed by a₁₂, and, finally, a₂₂, In this sequence, each memory access, after the first memory access, requires accessing an element not stored contiguously with the previously-accessed element. Thus, a total of four memory accesses may be required.

On the other hand, if a scan along the second dimension of the matrix A were computed (a column scan), then iterating over the first column may involve accessing contiguously-stored elements. In this case, the scan may be computed by loading two chunks, each consisting of two elements, from memory. The first chunk may contain the elements a₁₁ and a₁₂, while the second chunk may contain the elements a₂₁ and a₂₂. Thus, two memory accesses may be required.

The example of FIGS. 3a-3d illustrates that the memory efficiency of iterating along a selected dimension of a matrix to perform an operation (e.g., a scan or a reduction) may depend on whether the matrix is stored in row-major order or column-major order. Iterating over columns may be preferable when the matrix is stored in column-major order, whereas iterating over rows may be preferable when the matrix is stored in row major order.

It should be appreciated that when a multi-dimensional array is stored in column-major order, then naively iterating along the second dimension requires striding across the number of elements in the first dimension of the array. But, iterating along the third dimension requires striding across the number of elements in the first dimension multiplied by the number of elements in the second dimension of the array. In other words, iterating over the third dimension of an array stored in column-major order requires larger strides over memory elements than does iterating over the second dimension. More generally, the size of the stride (in terms of the number of memory locations) becomes larger with the dimension d along which an operation (e.g., scan or a reduction) is computed. Large strides, because they may require accessing elements stored far apart in memory, may require repeatedly accessing high-latency memory, which is undesirable due to the large amount of time it takes to access elements in high-latency memory.

Thus, it may be desirable to select a dimension-specific memory access strategy for accessing elements of a multi-dimensional array when iterating with respect to a selected dimension. In the above two-dimensional example, chunks of size one or two may be chosen depending on the dimension (first or second) along which an array is being accessed.

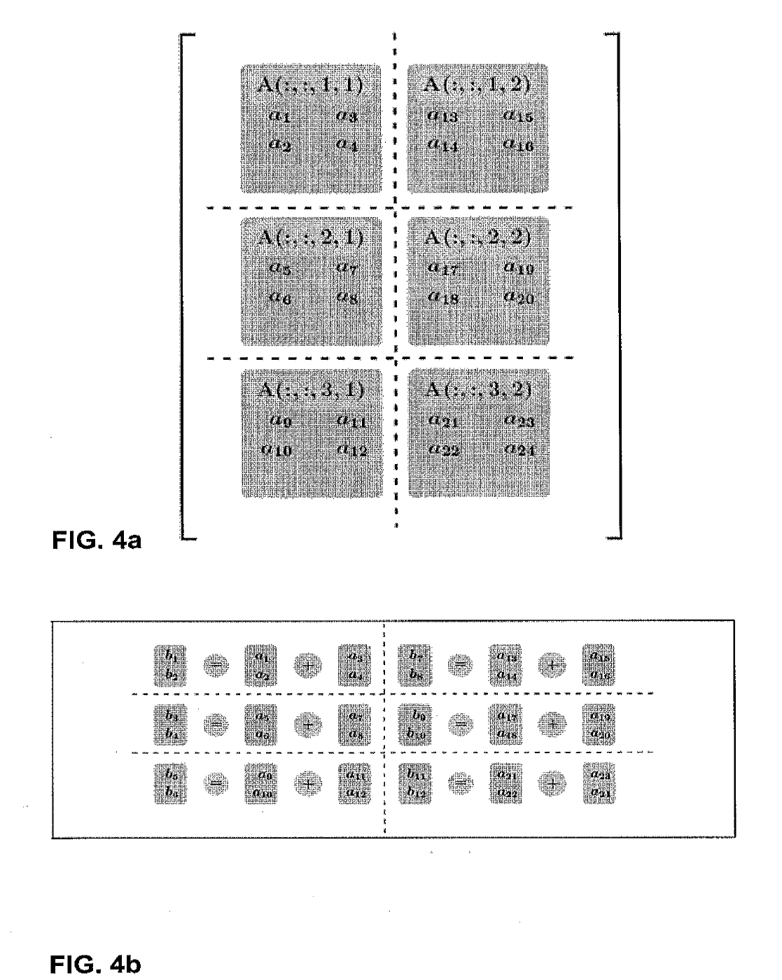

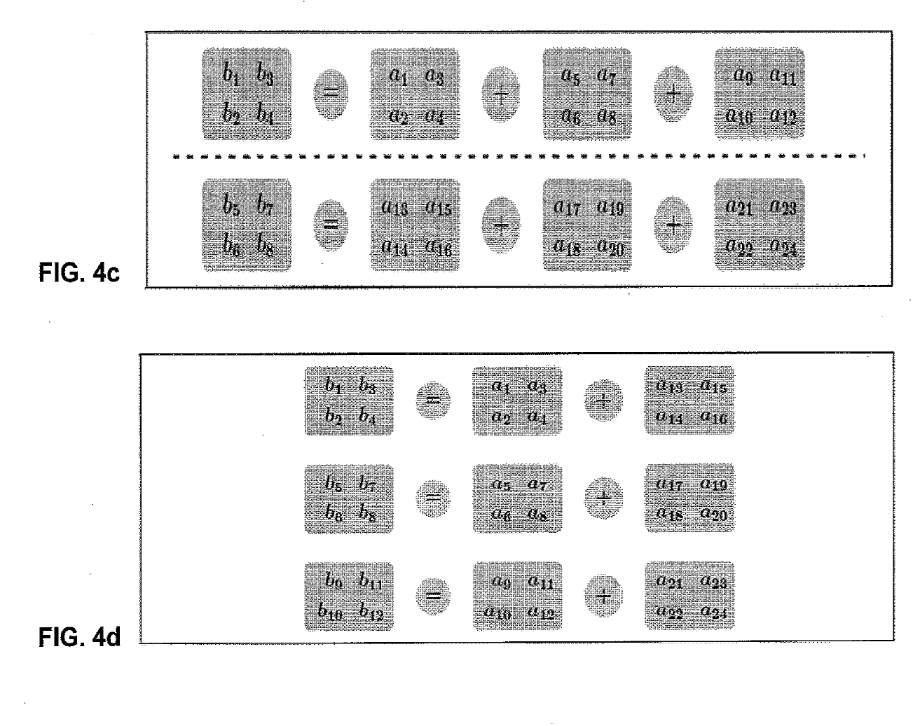

In some embodiments, the way in which array elements are accessed in memory to perform a scan or a reduction along a selected dimension of the array may depend on the selected dimension. A multi-dimensional array may be loaded from a memory, such as a high-latency memory, in chunks (i.e., a set of contiguously-stored elements). In some embodiments, determining the number of chunks, the number of elements in each chunk, and which elements of the array are in which chunk may be based at least on the selected dimension along which to perform the scan or reduction and on whether the array is stored in column-major or row-major form. This is further illustrated in FIGS. 4a-4d below.

FIGS. 4a-4d illustrate computing a reduction, based on the sum operation, along various dimensions of a prototypical four-dimensional array A of shape 2×2×3×2. As shown in FIG. 4a, the array A contains twenty four elements sequentially labeled as a₁, a₂, . . . a₂₄, and is stored in column-major order.

FIGS. 4b-4d illustrate the chunks involved in computing reductions along the second, third, and fourth dimension, respectively. FIG. 4b shows that chunks consisting of two elements may be used to compute the reduction along the second dimension. For instance, the chunk containing elements a₁ and a₂ may be combined with the chunk containing elements a3 and a4 to compute elements b₁ and b₂ in the output array. Though, this is merely a specific example and chunks of different sizes may be used to compute reductions along this dimension.

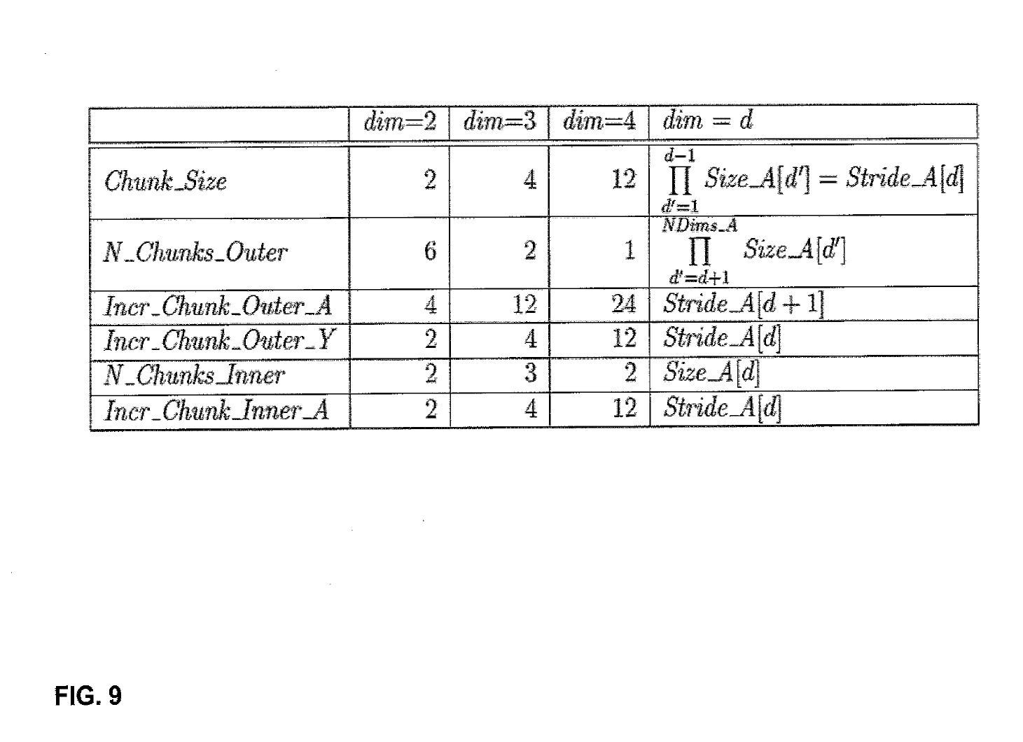

FIGS. 4c and 4d show that chunks consisting of four and twelve elements may be used to compute reductions along the third and fourth dimensions of A, respectively. In the example of FIG. 4d, the two chunks consist of elements aₗ through a₁₂, and a₁₃ through a₂₄. The manner in which these chunks and their sizes are selected will be described in greater detail below with reference to FIGS. 9 and 10.

The example described with reference to FIGS. 4a-4d is merely illustrative and is not limiting. Though the example illustrates computing a reduction using the sum operator for a four-dimensional array, techniques described herein may be applied to arrays of arbitrary dimension to compute any suitable operation along any dimension of the array. For instance, the techniques may be applied to operations such scans and reductions, using any suitable binary operator. More generally, the techniques may be applied to any operation requiring iterating along a selected dimension of a multi-dimensional array and minimizing the number of high-latency memory accesses while iterating over the array.

The examples of FIGS. 3a-3d and 4a-4d illustrate operations, such as scans and reductions, performed with respect to the entire multi-dimensional array under consideration. It may be desirable, however, to compute these same operations with respect to a selected dimension of a sub-array or a “view” of the multi-dimensional array. The number of elements in each dimension of a sub-array may be smaller than or equal to the number of elements in each dimension of the entire multi-dimensional array. Though typically, there is one dimension such that the number of sub-array elements in that dimension is strictly smaller than the number entire-array elements in that dimension.

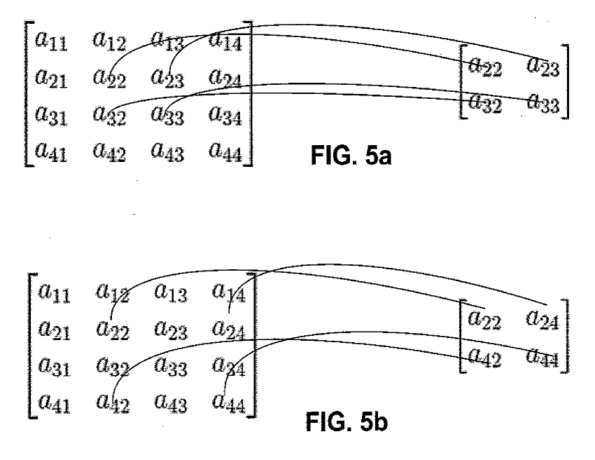

FIGS. 5a and 5b illustrate examples of two different sub-arrays of a 4×4 two-dimensional array. Note that elements in the sub-arrays are not necessarily stored contiguously in memory. In some embodiments, techniques disclosed herein may be applied to iterating over a sub-array of elements of an input multi-dimensional array to minimize the number of memory accesses when retrieving elements of the sub-array from a high-latency memory.

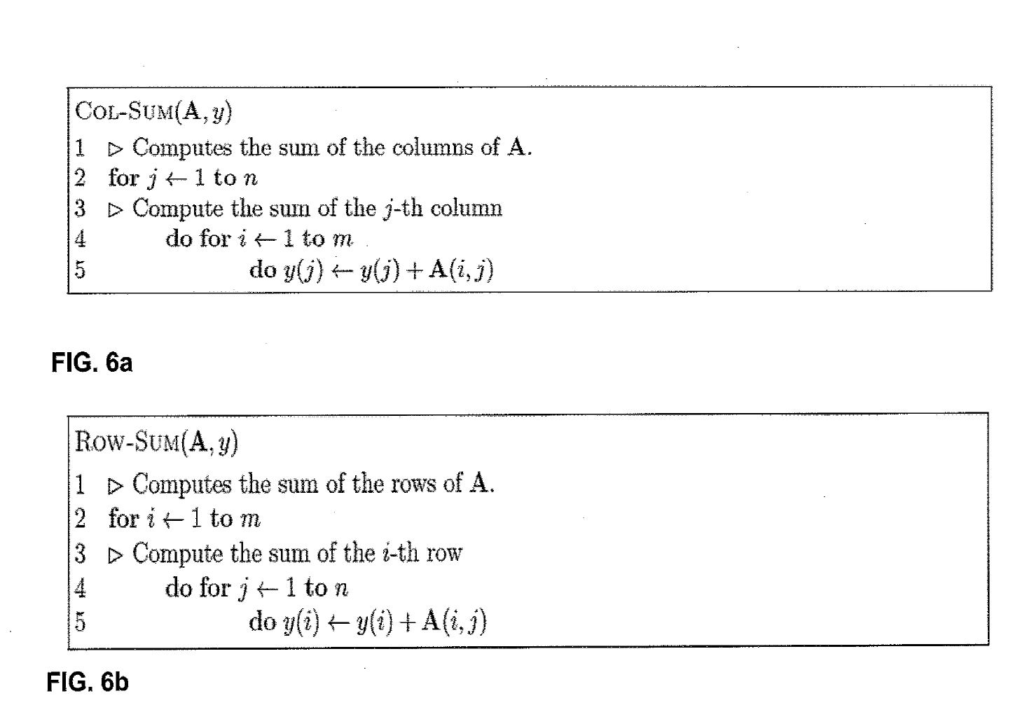

The example illustrated in FIGS. 4a-4d, comprises using different size chunks used for computing reductions (or scans) of a four-dimensional array. The method for selecting chunks of elements for loading from a memory for subsequent processing is now described with reference to FIGS. 6a-6b, 7a-7b, and 8-10.

FIGS. 6a and 6b describe algorithms for calculating column- and row-sums of two-dimensional matrices. As previously mentioned, these example operations are generally illustrative of scans, reductions and other operations that may require iterating over elements of a multi-dimensional array along a selected dimension. The column-sum of a two-dimensional array with n columns and m rows may be computed by a computer-program COL-SUM whose pseudo-code is shown in FIG. 6a. Similarly, the row-sum of the two-dimensional array may be computed by a computer program ROW-SUM as shown in FIG. 6b.

When an array is stored in column-major order, the loops in COL-SUM are arranged so that COL-SUM iteratively accesses elements contiguously stored in memory, whereas ROW-SUM involves striding over elements not contiguously stored in memory. The situation is reversed if the array is stored in row-major order. Accessing non-contiguously stored elements may result in multiple accesses of high-latency memory, affecting overall performance. In one experiment, Fortran 90 implementations of the routines COL-SUM and ROW-SUM, executed on moderately-sized matrices stored in column-major order on a modem workstation, showed that ROW-SUM was 20-30 times slower than COL-SUM.

The inventors obtained an insight for how to implement ROW-SUM in a memory-efficient way, without striding over non-contiguously stored elements of an array, by studying numerical linear algebra algorithms for matrix-vector multiplication.

The inventors observed that in two-dimensional matrices, the computation of scans or reductions may be reformulated as matrix-vector or vector-matrix multiplication problems. In particular, let eₙ=[1, 1, . . . , 1]^{T}, be an n-element column vector of ones. Then, it may be observed that the sum of the rows of an m×n two-dimensional array A may be computed as the matrix-vector product: Ae_{n.} Similarly, the sum of the columns of A may be computed as the vector-matrix product: eₙ^{T}A. Consequently, the inventors observed that the problem of efficiently computing row and column sums of a two-dimensional matrix may be reduced to the efficient computation of matrix-vector and vector-matrix products.

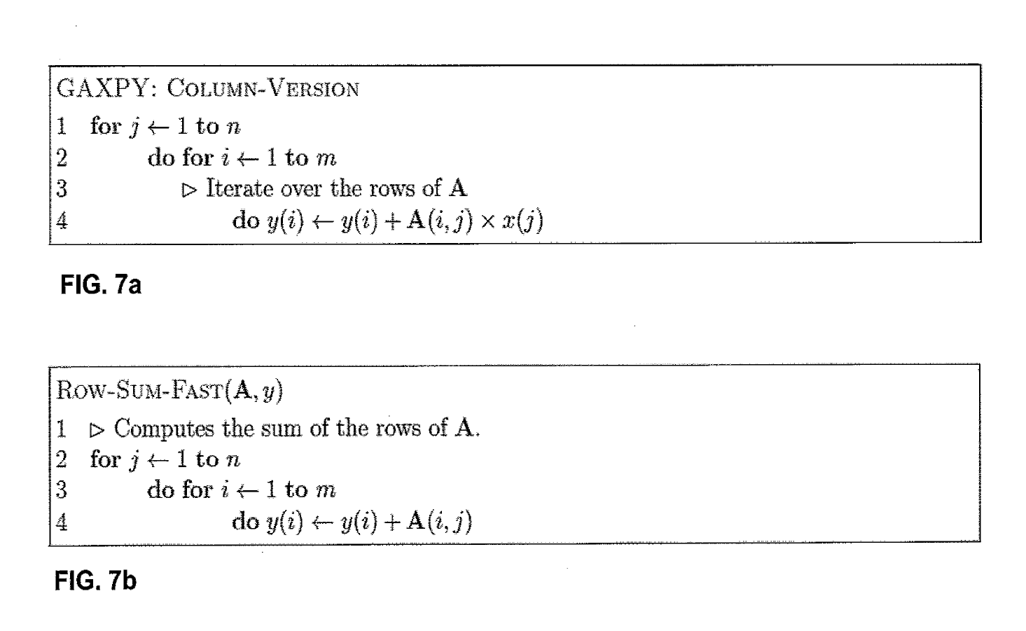

The computation of matrix-vector products is a fundamental operation in numerical linear algebra. The inventors appreciated that while the routine ROW-SUM, illustrated in FIG. 6a may not be memory efficient when applied to matrices stored in column-major order, insight for how to improve the routine ROW-SUM may be obtained from the computer program GAXPY: COLUMN-VERSION for matrix-vector multiplication shown in FIG. 7a. In particular, the program GAXPY: COLUMN-VERSION is very similar to ROW-SUM, but the loops are ordered differently. Due to this ordering of the loops, the matrix A is accessed only in a column-wise manner that does not require strided access along its rows. In other words, GAXPY computes row sums by accessing elements in such an order so as to iterate only over elements stored contiguously in memory.

Incorporating this insight, the computer program ROW-SUM may be re-organized as the routine ROW-SUM-FAST, which accesses contiguously stored elements instead of striding over elements not stored contiguously. The inventors have experimentally observed that COL-SUM and ROW-SUM-FAST have comparable performance in a number of representative testing scenarios.

The two-dimensional examples illustrated in FIGS. 6a, 6b, 7a and 7b suggested, to the inventors, a memory-efficient method for iterating over multi-dimensional arrays, stored either in row-major or in column-major order, that reduces the number of high-latency memory accesses.

In some embodiments, the proposed method may comprise decomposing any operation requiring iterating over elements of a multi-dimensional array along a selected dimension into a set of two-dimensional inner iterations. Each set of inner iterations may be used to iterate over contiguously-stored array elements in a manner similar to ROW-SUM-FAST. The operation may be any suitable operation including a scan or a reduction each of which, in turn, may comprise using any suitable binary operator such as addition, subtraction, multiplication and others. Additionally or alternatively, the operation may be any operation that requires access to elements of the multi-dimensional array (or to elements in a sub-array of the multi-dimensional array).

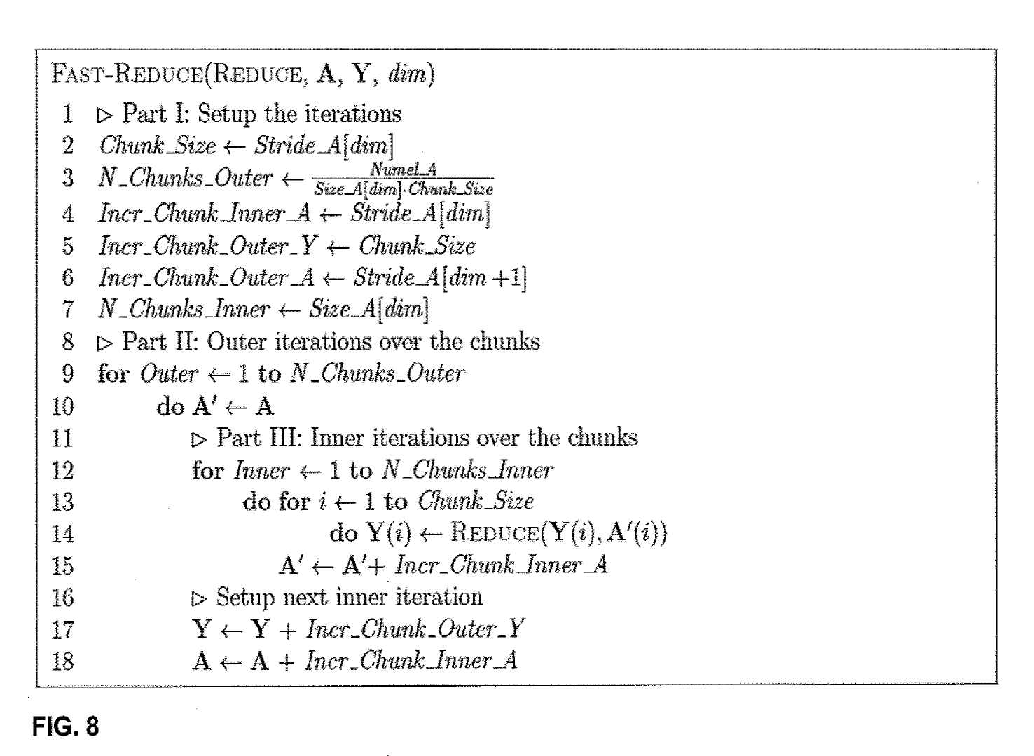

FIG. 8 shows pseudo-code for an illustrative computer program FAST-REDUCE for implementing a memory-efficient method for computing a reduction of an input multi-dimensional array A with respect to a selected dimension. The input multi-dimensional array may be stored either in row-major order or in column-major order. The multi-dimensional array may be dense or it may be sparse.

The array may be stored in a high-latency memory and it may be desirable to limit the number of high-latency memory accesses while computing the reduction. Though it should be appreciated that FAST-REDUCE is merely illustrative and may be modified in any of numerous ways to achieve the same functionality. Moreover, though the program of FIG. 8 is written in pseudo-code, as is customary in the art, the program may be implemented in any suitable programming language. For instance, it may be implemented in C, C++, or Java. Alternatively it may be implemented using Fortran 77, Fortran 90, or NumPy. Any suitable programming language and/or computing environment may be used. For instance, a C++ implementation of FAST-REDUCE is included as Appendix A.

The computer program of FIG. 8 has four inputs: a binary operator REDUCE, an input multi-dimensional array A, a multi-dimensional array Y for storing output, and a selected dimension dim. The operator REDUCE may be any of numerous operators such as the addition or a multiplication operator, a minimum operator, or any other suitable binary operator. The dimension dim may be any integer between 1 and the number of dimensions in the input multi-dimensional array, inclusive. A and Y may be multi-dimensional arrays or handles to these arrays such as pointers (i.e., memory addresses) at which an element of A or Y may be stored, respectively.

Though in other embodiments, more than four inputs may be provided to FAST-REDUCE. For instance, some of the parameters such as Chunk_Size and Incr_Chunk_Outer may be provided to FAST-REDUCE and may not need be computed. Alternatively, less than four inputs may be provided to FAST-REDUCE. For instance, in some embodiments reductions may always be performed along a particular selected dimension so that it may be unnecessary to provide a selected dimension to FAST-REDUCE every time FAST-REDUCE is invoked. In some embodiments, a handle to the output array Y may not be provided if the operations were to be done in place such that entries of the input array may be altered during execution of FAST-REDUCE. Alternatively, the location of the output array Y may be predetermined or selected during the operation of the computer program.

In the illustrated embodiment, the computer program FAST-REDUCE comprises three parts, indicated by Part I, Part II, and Part III of the pseudo-code. In Part I, the program may calculate parameters that may be used for subsequent computations. The parameters may be calculated based on values descriptive of the input array A stored in the vectors Size_A and Stride_A, as well as the selected dimension dim and the number of elements in the input multi-dimensional array.

The vector Size_A may store the shape of the input array. If the input array is D dimensional, then the vector Size_A may store D entries such that the d^{th} entry stores the number of elements in A along dimension d. For instance, the Size_A vector for the four-dimensional array illustrated in FIG. 4a is given by {2, 2, 3, 2}.

Values stored in the vector Stride_A may represent the number of elements in memory between two elements consecutively indexed at dimension d. More formally, values of Stride_A may be computed according to:

$$Stride\_A [ d ] = {\prod }_{{d}^{′} = 1}^{d - 1} Size\_A [ {d}^{′} ]$$

For instance, the Stride_A vector for the four-dimensional array illustrated in FIG. 4a is given by {1, 2, 4, 12, 24}. The Stride_A vector may comprise one more entry than the Size-A vector.

The parameters computed in Part I of FAST-REDUCE may control the manner in which FAST-REDUCE may access elements of the input multi-dimensional array. For instance, the total number of chunks accessed from memory is given by N_Chunks_Outer multiplied by N_Chunks_Inner. In addition, the size of each chunk is determined by the parameter Chunk_Size.

It should be appreciated that the parameters computed in Part I of FAST-REDUCE may depend on the selected dimension dim. For example, FIG. 9 illustrates the parameters computed by FAST-REDUCE for the illustrative four-dimensional array shown in FIGS. 4a-4d. Note that, in this example, the parameters depend on the selected dimension. Though in other embodiments, some of the parameters may be computed without taking the selected dimension into account.

In Parts II and III, FAST-REDUCE may iterate over chunks, as specified by the parameters computed in Part I. Iterating over chunks may comprise loading a new chunk and performing an operation on each element of every chunk. FAST-REDUCE, for instance, comprises set of inner iterations such that an operation may be performed on each element of each chunk during each inner iteration. The inner iterations are composed into a set of outer iterations. In this example, the operation is an arbitrary reduction operation REDUCE.

Though in this example FAST-REDUCE computes a reduction of a multi-dimensional array along a selected dimension, this is merely illustrative and not limiting of the embodiments. For instance, FAST-REDUCE may be modified to perform an operation other than a reduction on the input multi-dimensional array. For instance, it may be modified to perform a scan operation. Alternatively, it may be modified to implement any other data processing operation that requires accessing all the elements of the input multidimensional array A, while reducing the number of high-latency memory accesses.

FIG. 10 shows a flow chart of an illustrative process 200 that may be used to iterate over elements of a multi-dimensional array and perform an operation on the elements. The process begins with the input of a multi-dimensional array in act 202. The multi-dimensional array may be input in any of numerous ways. For instance, a memory address of an element (e.g., the first element) in the multi-dimensional array may be provided. Additionally or alternatively, a range of memory addresses, indicating the memory locations at which array elements are stored, may be provided to the process 200. Still another possibility is that a set of array elements may be input along with one or more pointers (e.g., memory addresses) to one or more array elements. Many other ways of inputting a multi-dimensional array will be apparent to those skilled in the art.

The multi-dimensional array may be stored in high-latency memory such as high-latency memory 110 described with reference to FIG. 1. The multi-dimensional array may be stored in row-major order or in column-major order.

It should be appreciated that memory addresses or pointers may be addressing virtual memory and not physical memory. However, any such level of indirection (e.g., virtual memory addressing functionality provided by an operating system) may be implemented transparently to the methods described herein.

In act 204, an operation to perform on elements of the multi-dimensional array is input and a dimension along which to apply the operation is also provided. The operation may be any of numerous operations that may be applied to elements of the multi-dimensional array along a selected dimension of the array. For instance, the operation may be a reduction or a scan operation. The reduction or scan operation may comprise any suitable binary operator such as addition, multiplication, or any of the previously-mentioned binary operators and others known in the art. Alternatively, the operation may be any operation requiring iterating over elements of the array along a selected dimension. For instance, the operation may be a printing operation to print all elements of the array or may be a sending operation to send all elements of the array to another application.

The input dimension may be any dimension of the multi-dimensional array input in act 202. For instance, if the multi-dimensional array has D dimensions, then the input dimension may be any positive integer between one and D, inclusive. In other embodiments, a dimension along which to perform an operation may be selected a priori or dynamically determined based on the data in the multi-dimensional array.

To iterate over elements of a multi-dimensional array, the array may be divided into chunks of contiguously-stored elements. The chunks may all consist of the same number of array elements or there may be a chunk that contains a different number of elements than another chunk. A chunk size (i.e., the number of elements in a chunk) may be computed in act 206 of the process 200. The chunk size computed in act 206 may be the size of one or more chunks.

The chunk size may be computed in any of numerous ways. For instance, the chunk size may be calculated based on a dimension of the multi-dimensional array, with the dimension input in act 204 or otherwise specified. Additionally or alternatively, the chunk size may depend on the shape of the input multi-dimensional array and on how the matrix is stored. In some embodiments, the chunk size may depend on all these factors. For instance, as shown in the table of FIG. 9, the chunk size may be obtained according to:

$$ChunkSize = {\prod }_{{d}^{′} = 1}^{d - 1} Size\_A [ {d}^{′} ] ,$$

where A is the input D-dimensional dimensional array stored in column-major order, Size_A is a vector storing the shape of A, and d is the input dimension. Alternatively, if A is a D-dimensional array stored in row-major order, then the chunk size may be obtained according to:

$$ChunkSize = {\prod }_{{d}^{′} = D}^{D - d + 2} Size\_A [ {d}^{′} ] .$$

More generally, a chunk-size may be defined based on the Size_A vector with respect to any arbitrary sequencing of dimensions and not only column-major or row-major orders, which correspond to two particular orders of dimensions (i.e., first to last and last to first, respectively).

Next, in act 208 of the process 200, a sequence of chunks to be accessed is determined. The sequence of chunks to be accessed may be determined in any of numerous ways. For instance, the sequence may be dynamically determined based on at least the shape of the multi-dimensional array and the selected dimension. Alternatively, the sequence of chunks may be specified a priori.

The sequence of chunks may be specified through a number of parameters. Such a sequence may be parameterized in any suitable manner. For instance, a set of parameters specifying a chunk sequence may comprise the size of each chunk in the sequence, the total number of chunks, and the increment from a memory address, at which the first element of one chunk in the sequence is stored, to a memory address at which the first element of another chunk in the sequence is stored (i.e., the stride from one element to the next). Another example parameter set for specifying a chunk sequence is the set of parameters computed in Part I of the computer-program shown in FIG. 8. In this example, the computed set of parameters may specify a sequence of chunks to be accessed by the computer program in Part II and Part III (access occurs during the outer and inner iterations over chunks).

In some embodiments, the chunks may be accessed in any of numerous sequences—the access sequence need not be unique. For instance, the sequence in which chunks are accessed in the pseudo-code shown in FIG. 8 may be altered (e.g., at least one of the two loop counters may count down instead of counting up) to arrive at another (reversed) access sequence. As a further example, the chunks separated by dashed lines as shown in the examples of FIGS. 4b-4c may be accessed in any suitable order.

Next, the process 200 may iterate over the sequence of chunks loading each chunk in a sequence into a memory and further iterating over elements in the loaded chunk to perform an operation on each element of the loaded chunk.

In act 210, a chunk in the sequence of chunks identified in act 208 may be loaded to a second memory from a first memory. The first memory may be a high-latency memory (e.g., a hard drive, USB key). The second memory may be low-latency memory such that the latency of the second memory is lower than the latency of the first memory. For instance, the second memory may be an onboard processor cache.

After a chunk is loaded to a second memory in act 210, the process 200 branches, at decision block 212, depending on the type of processor that may be used to perform the inputted operation on those elements of the multi-dimensional array that are in the loaded chunk. The processor may be a central processing unit (CPU) such as the CPU 140 shown in FIG. 1 or a graphics processing unit (GPU) such as the GPU 142 also shown in FIG. 1. Though, the data may be processed by one or more CPUs and/or one or more GPUs as the embodiments are not limited by the type and number of processor used to apply the operation to the elements in each chunk.

If it is determined that the operation is to be applied by processor, such as a central processing unit (CPU), then process 200 proceeds to act 214, otherwise process 200 proceeds to act 216. In either case, the processor (CPU or GPU) may be used to apply the operation to elements in the loaded chunk. For instance, the process 200 may applied to compute a scan operation to calculate cumulative products along a selected dimension of an input multi-dimensional array, and the processor may be used to compute a product of at least two elements in the loaded chunk. Additionally or alternatively, the processor may be used to compute a product between an element in the loaded chunk and another value stored in the second memory. The other value may be any suitable value and may, for instance, be a partial product of elements from one or more chunks.

After the operation has been applied by a processor to a loaded chunk, process 200 proceeds to decision block 218 at which process 200 branches depending on whether there are any additional chunks of array elements to process (i.e., apply operation to). If there are more chunks to be processed, process 200 continues to block 219 where the location of the next chunk to process is computed. Then, the process 200 loops back to block 210, where another chunk is loaded into a low-latency memory from a high-latency memory. The location of the next chunk to process may be computed using the parameters that specify the sequence of chunks to access. For instance, such parameters may have been obtained in act 208 of the process 200. Processing at blocks 212, 214 and 216 is repeated, to apply the operation to elements of the loaded chunks. Processing proceeds iteratively in this fashion until, as determined at decision block 218, that there are no more chunks to process, the process 200 terminates.

It should be appreciated that the process 200 is merely illustrative and many modifications of the process 200 are possible. For instance, processing may be performed in parallel by a plurality of processors and/or computers. To this end, operations on elements of each chunks in the sequence of chunks may be performed by a distinct processor and any steps known in the art for parallelizing computation and memory access may be applied. Another example is that multiple operations may be performed on the input array in one pass across the elements of the array. For instance, a scan comprising a sum operator and a reduction comprising a multiplication operator may be computed together on each loaded chunk, resulting in two output multi-dimensional arrays.

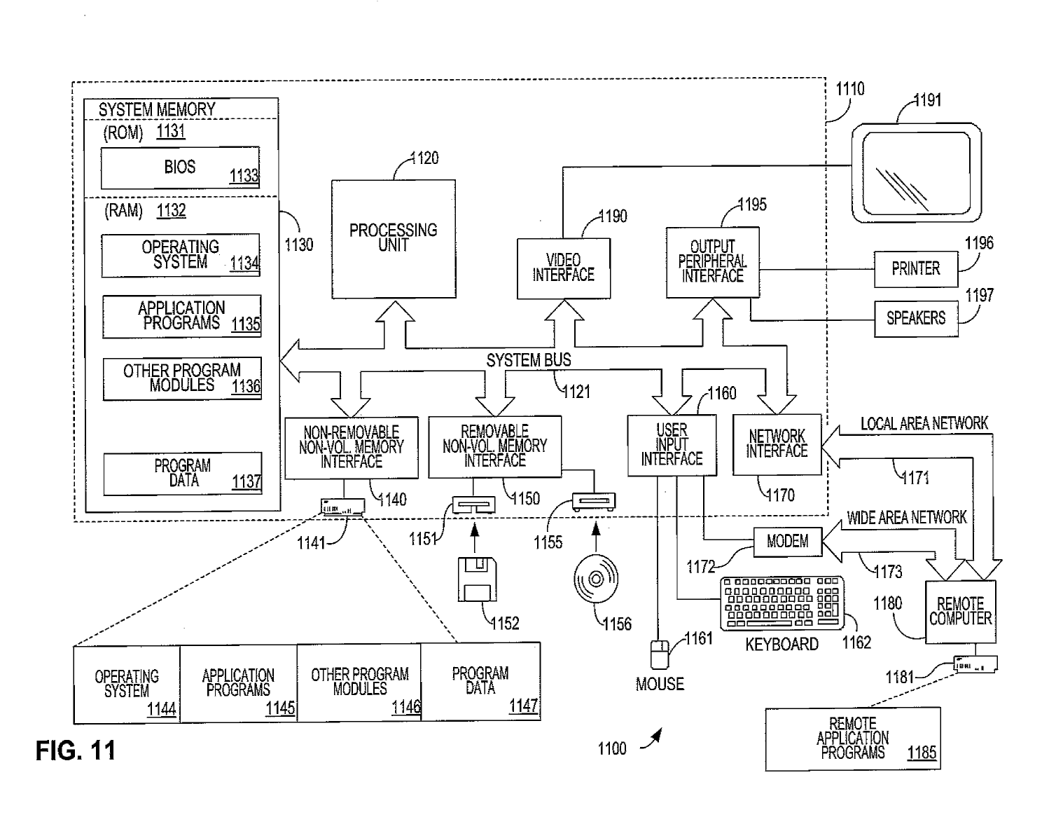

FIG. 11 illustrates an example of a suitable computing system environment 1100 on which the invention may be implemented. The computing system environment 1100 is only one example of a suitable computing environment and is not intended to suggest any limitation as to the scope of use or functionality of the invention. Neither should be computing environment 1100 be interpreted as having any dependency or requirement relating to any one or combination of components illustrated in the exemplary operating environment 1100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communication network. In a distributed computing environment, program modules may be located in both local and remote computer storage media including memory storage devices.

With reference to FIG. 11, an exemplary system for implementing the invention includes a general purpose computing device in the form of a computer 1110. Components of computer 1110 may include, but are not limited to, a processing unit 1120, a system memory 1130, and a system bus 1121 that couples various system components including the system memory to the processing unit 1120. The system 1121, may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1110 typically includes a variety of computer readable media. Computer readable media can be any available media that can be accessed by computer 1110 and includes both volatile and nonvolatile media, removable and non-removable media. By way of example, and not limitation, computer readable media may comprise computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1110. Combinations of the any of the above should also be included within the scope of computer readable storage media.

The system memory 1130 includes computer storage media in the form of volatile and/or nonvolatile memory such as read only memory (ROM) 1131 and random access memory (RAM) 1132. A basic input/output system 1133 (BIOS), containing the basic routines that help to transfer information between elements within computer 1110, such as during start-up, is typically stored in ROM 1131. RAM 1132 typically contains data and/or program modules that are immediately accessible to and/or presently being operated on by processing unit 1120. By way of example, and not limitation, FIG. 11 illustrates operating system 1134, application programs 1135, other program modules 1136, and program data 1137.

The computer 1110 may also include other removable/non-removable volatile/nonvolatile computer storage media. By way of example only, FIG. 11 illustrates a hard disk drive 1140 that reads from or write to non-removable, nonvolatile magnetic media, a magnetic disk drive 1151 that reads from or writes to a removable, nonvolatile magnetic disk 1152, and an optical disk drive 1155 that reads from or writes to a removable, nonvolatile optical disk 1156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1141 is typically connected to the system bus 1121 through a non-removable memory interface such as interface 1140, and magnetic disk drive 1151 and optical disk drive 1155 are typically connected to the system bus 1121 by a removable memory interface, such as interface 1150.

The drives and their associated computer storage media, discussed above and illustrated in FIG. 11, provide storage of computer readable instructions, data structures, program modules and other data for the computer 1110. In FIG. 11, for example, hard disk drive 1141 is illustrated as storing operating system 1144, application programs 1145, other program modules 1146, and program data 1147. Note that these components can either be the same as or different from operating system 1134, application programs 1135, other program modules 1136, and program data 1137. Operating system 1144, application programs 1145, other program modules 1146, and program data 1147 are given different numbers here to illustrate that, at a minimum, they are different copies.

A user may enter commands and information into the computer 1110 through input devices such as a keyboard 1162 and pointing device 1161, commonly referred to as a mouse, trackball or touch pact. Other input devices may include a microphone 1163, joystick, a tablet 1164, satellite dish, scanner, or the like. These and other input devices are often connected to the processing unit 1120 through a user input interface 1160 that is coupled to the system bus, but may not be connected by other interface and bus structures, such as a parallel port, game port or a universal serial bus (USB). A monitor 1191 or other type of display device is also connected to the system 1121 via an interface, such as a video interface 1190. In addition to the monitor, computers may also include other peripheral output devices such as speakers 1197 and printer 1196, which may be connected through a output peripheral interface 1195.

The computer 1110 may operate in a networked environment using logical connections to one or more remote computers, such as a remote computer 1180. The remote computer 1180 may be a personal computer, a server, a router, a network PC, a peer device or other common network node, and typically includes many or all of the elements described above relative to the computer 1110, although only a memory storage device 1181 has been illustrated in FIG. 11. The logical connections depicted in FIG. 11 include a local area network (LAN) 1171 and a wide area network (WAN) 1173 and a wireless link, for example via a wireless interface 1197 complete with an antenna, but may also include other networks. Such networking environments are commonplace in offices, enterprise-wide computer networks, intranets and the Internet. While wireless interface 1197 is shown directly connected to system bus 1121, it is recognized that the wireless interface 1197 may be connected to system bus 1121 via network interface 1170.

When used in a LAN networking environment, the computer 1110 is connected to the LAN 1171 through a network interface or adapter 1170. When used in a WAN networking environment, the computer 1110 typically includes a modem 1172 or other means for establishing communications over the WAN 1173, such as the Internet. The modem 1172, which may be internal or external, may be connected to the system bus 1121 via the user input interface 1160, or other appropriate mechanism. In a networked environment, program modules depicted relative to the computer 1110, or portions thereof, may be stored in the remote memory storage device. By way of example, and not limitation, FIG. 11 illustrates remote application programs 1185 as residing on memory device 1181. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for performing an operation on data represented as elements of a first multi-dimensional array, the method comprising:
performing a plurality of iterations to compute output comprising one or more multi-dimensional arrays, the one or more multi-dimensional array comprising at least a second multi-dimensional array, each iteration in the plurality of iterations comprising:
selecting a plurality of elements of the first multi-dimensional array, based at least on a selected dimension of the first multi-dimensional array, wherein elements of the selected plurality of elements are stored contiguously in a first memory,
loading the selected plurality of elements into a second memory,
applying an operator requiring two operands to each element of the selected plurality of elements and another element stored in the second memory, using at least one processor,
wherein the first multi-dimensional array has at least three dimensions and is stored in the first memory in row-major order.

2. The method of claim 1, wherein:
the first memory has a first latency;
the second memory has a second latency; and
the second latency is smaller than the first latency.

3. The method of claim 1, wherein selecting the plurality of elements of the first multi-dimensional array is further based on how many elements are in each dimension of the multi-dimensional array.

4. The method of claim 3, wherein selecting the plurality of elements of the first multi-dimensional array at each iteration of the plurality of iterations further comprises:
calculating a number of elements in the plurality of elements; and
calculating a memory location of an element in a plurality of elements to be accessed at a subsequent iteration.

5. The method of claim 4, wherein the number of elements in the plurality of elements is determined based on multiplying a number of elements in each of one or more dimensions of the first multi-dimensional array.

6. The method of claim 1, wherein the first multi-dimensional array and the second multi-dimensional array have the same number of dimensions.

7. The method of claim 6, wherein the number of elements in the selected dimension of the first multi-dimensional array is the same as the number of elements in a dimension of the second multi-dimensional array corresponding to the selected dimension of the first multi-dimensional array.

8. The method of claim 3, wherein the number of elements in the selected dimension of the first multi-dimensional array is less than the number of elements in a dimension of the second multi-dimensional array corresponding to the selected dimension of the first multi-dimensional array.

9. The method of claim 1, wherein the operator implements an operation selected from the group consisting of adding, multiplying, dividing, subtracting, selecting the minimum of two elements, selecting the maximum of two elements, returning the location of the minimum of two elements, and returning the location of the maximum of two elements.

10. The method of claim 1, wherein the first multi-dimensional array is stored in the first memory such that only the non-zero elements of the first multi-dimensional array are stored in the first memory.

11. The method of claim 1, wherein each selected plurality of elements only contains elements from a sub-array of the first multi-dimensional array.

12. A system for performing an operation on data represented as elements of a first multi-dimensional array, the system comprising:
a first memory to store the first multi-dimensional array in row-major order, the first multi-dimensional array having at least three dimensions; and
at least one processor coupled to at least a second memory, the at least one processor programmed to perform a plurality of iterations to compute a second multi-dimensional array, each iteration in the plurality of iterations comprising:
selecting a plurality of elements of the first multi-dimensional array, based at least on a selected dimension of the first multi-dimensional array, wherein elements of the selected plurality of elements are contiguously stored in the first memory,
loading the selected plurality of elements into the second memory, and
applying an operator requiring two operands to each element of the selected plurality of elements and another element stored in the second memory.

13. The system of claim 12, wherein the at least one processor comprises at least one graphical processing unit for accessing the plurality of elements in the second memory and applying the operator requiring two operands to each element of the plurality of elements and another element stored in the second memory.

14. The system of claim 12, wherein:
the first memory has a first latency;
the second memory has a second latency; and
the second latency is smaller than the first latency.

15. The system of claim 12, wherein selecting the plurality of elements of the first multi-dimensional array is further based on how many elements are in each dimension of the multi-dimensional array.

16. The method of claim 12, wherein selecting the plurality of elements of the first multi-dimensional array at each iteration of the plurality of iterations further comprises:
calculating a number of elements in the plurality of elements; and
calculating a memory location of an element in a plurality of elements to be accessed at a subsequent iteration.

17. The method of claim 4, wherein the number of elements in the plurality of elements is determined based on multiplying a number of elements in each of one or more dimensions of the first multi-dimensional array.

18. A computer-readable storage medium encoded with a utility comprising processor-executable instructions that, when executed by at least one processor, cause the processor to perform a plurality of iterations to compute a second multi-dimensional array from a first multi-dimensional array, each iteration in the plurality of iterations comprising:
selecting a plurality of elements of the first multi-dimensional array, based at least on a selected dimension of the first multi-dimensional array and how many elements are stored in each dimension of the first multi-dimensional array, wherein elements of the selected plurality of elements are contiguously stored in a first memory,
loading the selected plurality of elements into a second memory, the second memory containing another plurality of elements, wherein each element of the selected plurality of elements has a corresponding element in the other plurality of elements,
applying an operator requiring two operands to each element of the selected plurality of elements and its corresponding element in the other plurality of elements,
wherein the first multi-dimensional array has at least three dimensions and is stored in the first memory in row-major order.

19. The computer-readable storage medium of claim 18, wherein the utility is provided a plurality of inputs, the plurality of inputs comprising:
the first multi-dimensional array,
the selected dimension; and
the operator requiring two operands.

20. The computer-readable storage medium of claim 19, wherein the operator implements an operation selected from the group consisting of: adding, multiplying, dividing, subtracting, selecting the minimum of two elements, and selecting the maximum of two elements.
